(19) United States
(12) Patent Application Publication
(10) Pub. No.: US 2025/0045964 A1
(43) Pub. Date: Feb. 6, 2025

(54) IMAGE FORMING APPARATUS, IMAGE FORMING METHOD, AND NON-TRANSITORY COMPUTER-READABLE RECORDING MEDIUM

(71) Applicant: Sharp Kabushiki Kaisha, Osaka (JP)

(72) Inventor: TAKASHI USUI, Osaka (JP)

(21) Appl. No.: 18/782,161

(22) Filed: Jul. 24, 2024

(30) Foreign Application Priority Data
Aug. 2, 2023 (JP) 2023-126042

(51) Int. Cl. G06T 7/90; G06T 7/00; G06T 7/11

(52) U.S. Cl. CPC G06T 7/90; G06T 7/0008; G06T 7/11; G06T 2207/10024; G06T 2207/30144

(57) ABSTRACT

An image forming apparatus includes a controller and an image former. The controller acquires color information indicating a value of color with respect to each pixel of a region of interest including a pixel of interest among a plurality of pixels constituting an image, and at least one reference pixel different from the pixel of interest among the plurality of pixels, and determines, on the basis of the color information, whether or not to apply color material total amount regulation for the color material made to adhere with respect to the pixel of interest. The image former forms the image on the recording material by causing the color material to adhere to the recording material on the basis of a result of determination by the controller.

### CROSS-REFERENCE TO RELATED APPLICATION

The present application claims priority from Japanese Application JP2023-126042, filed on Aug. 2, 2023, the content of which is hereby incorporated by reference into this application.

### BACKGROUND

### 1. Field

The present disclosure relates to an image forming apparatus, an image forming method, and a non-transitory computer-readable recording medium.

### 2. Description of the Related Art

As a conventional technology, there has been known a technology of determining, on the basis of a density value of each color obtained after gradation correction, whether a color material total amount falls within a predetermined total amount regulation value, and uniformly increasing or decreasing, when the color material total amount based on the density values of the respective colors obtained after the gradation correction is greater than or equal to the total amount regulation value, the density value of each CMYK color component exhibited before the gradation correction until the color material total amount falls within the predetermined total amount regulation value.

Furthermore, as the conventional technology, there has been known a technology of updating a weight parameter calculated on the basis of the specific gravities of saturation and darkness, and an ink total amount regulation value corresponding to a recording material such that a total value of the C value, the M value, the Y value, and the K value of each pixel becomes an ink usable amount, executing pseudo gradation processing on the updated CMYK data, and creating print data.

### SUMMARY

In the technology known as the conventional technology, color material total amount regulation is applied to each pixel. Therefore, in the technology known as the conventional technology, in a case where a total amount of the color materials is regulated for a region having a relatively small area, the region may become unclear on a recording material on which an image is formed. Hence, an object of one aspect of the present disclosure is to provide an image forming apparatus, an image forming method, and a non-transitory computer-readable recording medium capable of causing an appropriate amount of color material to adhere to a recording material and also preventing the recording material from becoming unclear.

An image forming apparatus according to one embodiment of the present disclosure comprises a controller, and an image former. The controller acquires color information indicating a value of color with respect to each pixel of a region of interest including a pixel of interest among a plurality of pixels constituting an image, and at least one reference pixel different from the pixel of interest among the plurality of pixels, and determines, on the basis of the color information, whether or not to apply color material total amount regulation for the color material made to adhere with respect to the pixel of interest. The image former forms the image on the recording material by causing the color material to adhere to the recording material on the basis of a result of determination by the controller.

An image forming method according to one embodiment of the present disclosure includes: acquiring color information indicating a value of color with respect to each pixel of a region of interest including a pixel of interest among a plurality of pixels constituting an image, and at least one reference pixel different from the pixel of interest among the plurality of pixels; determining, on the basis of the color information, whether or not to apply color material total amount regulation for a color material made to adhere with respect to the pixel of interest; and causing the color material to adhere to a recording material on the basis of a determination result and forming the image on the recording material.

A non-transitory computer-readable recording medium according to one embodiment of the present disclosure stores therein a program which causes a computer to implement: acquiring color information indicating a value of color with respect to each pixel of a region of interest including a pixel of interest among a plurality of pixels constituting an image, and at least one reference pixel different from the pixel of interest among the plurality of pixels; determining, on the basis of the color information, whether or not to apply color material total amount regulation for a color material made to adhere with respect to the pixel of interest; and causing the color material to adhere to a recording material on the basis of a determination result and forming the image on the recording material.

### BRIEF DESCRIPTION OF THE DRAWINGS

FIG. 1 is a block diagram illustrating an example of a configuration of an image forming apparatus according to a first embodiment.

FIG. 2 is a table showing an example of color material total amount management information.

FIG. 3 is a flowchart showing an example of the operation of the image forming apparatus according to the first embodiment.

FIG. 4 is a diagram illustrating an example of a pixel region to which color material total amount regulation is applied.

FIG. 5 is a flowchart showing an example of the operation of an image forming apparatus according to a second embodiment.

FIG. 6 is a diagram illustrating an object included in an image output when color material total amount regulation is not applied, an example of an object included in an image output by the image forming apparatus according to the first embodiment, and an example of an object included in an image output by the image forming apparatus according to the second embodiment.

FIG. 7 is a block diagram illustrating an example of a configuration of an image forming apparatus according to a fourth embodiment.

FIG. 8A is a graph showing an example of a relationship among a color difference from paper white, an adhesion amount, and a color information value of an output color channel.

FIG. 8B is a graph showing an example of a relationship between a color information value of an output color channel and an adhesion amount.

FIG. 9 is a flowchart showing an example of the operation of the image forming apparatus according to the fourth embodiment.

FIG. 10A is a flowchart showing an example of the operation of an image forming apparatus according to a fifth embodiment.

FIG. 10B is a flowchart showing an example of the operation of the image forming apparatus according to the fifth embodiment in continuation of FIG. 10A.

FIG. 11A is an illustration showing an example of a region where a color material adheres to a recording material.

FIG. 11B is an illustration showing an example of a region where a color material adheres to a recording material.

FIG. 12A is a diagram illustrating an example of a relationship between a pixel of interest and a pixel different from the pixel of interest within a region of interest in an image forming apparatus according to a seventh embodiment.

FIG. 12B is a diagram illustrating an example of a recording material on which a register mark for printed product management is printed.

### DETAILED DESCRIPTION OF THE DISCLOSURE

### First Embodiment

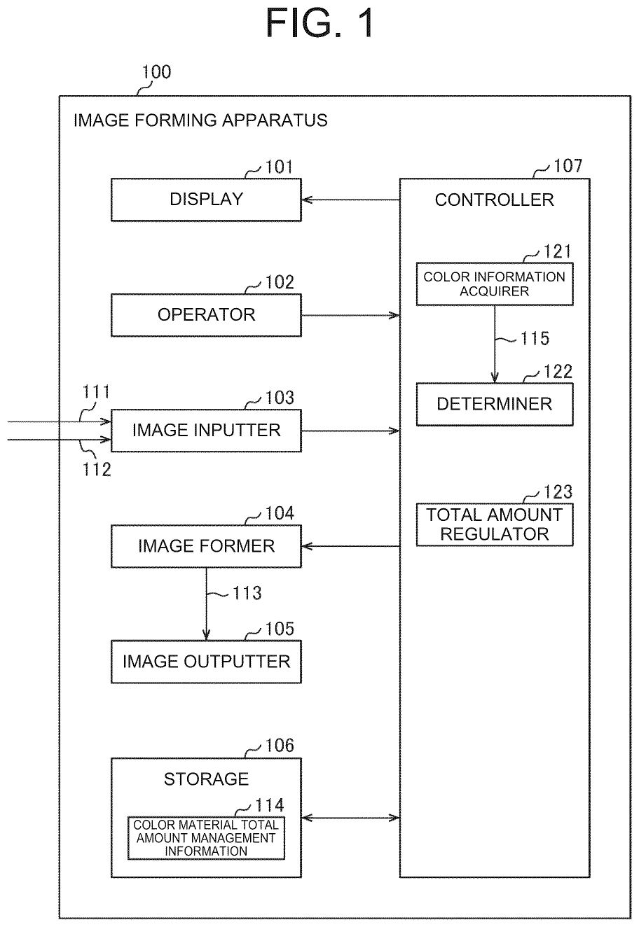

A first embodiment will be described with reference to FIGS. 1 to 4. In the drawings, the same or similar elements are denoted by the same reference numerals, and redundant description thereof will be omitted.

FIG. 1 is a block diagram illustrating an example of a configuration of an image forming apparatus 100 according to the present embodiment. The image forming apparatus 100 is provided with a display 101, an operator 102, an image inputter 103, an image former 104, an image outputter 105, a storage 106, and a controller 107.

The display 101 displays information to be presented to a user. For example, the display 101 is composed of a liquid crystal panel, an organic electro-luminescence (EL) panel, or the like.

The operator 102 receives an operation by the user. For example, the operator 102 is configured from a hard key, a button, a touch panel, and the like.

The image inputter 103 receives input of image information 111. The image information 111 indicates pixel values of a plurality of pixels constituting an image 113.

Alternatively, the image inputter 103 may receive input of a document printout and generate the image information 111 from the input document printout. For example, when the image inputter 103 receives input of a document printout, the image inputter 103 generates the image information 111 by reading the document printout with an image sensor such as a charge-coupled device (CCD) or a contact image sensor (CIS).

Further, the image inputter 103 receives input of recording material information 112. The recording material information 112 indicates the type of a recording material and the like. For example, the type of the recording material is the type of paper.

The image former 104 forms the image 113 based on the image information 111 on a recording material by causing a color material to adhere to the recording material. For example, the image former 104 may be constituted by a laser printer using an electrophotographic method or an inkjet printer using an inkjet method. When the image former 104 is constituted by a laser printer, the image former 104 forms the image 113 on a recording material by causing toner, which is the color material, to adhere to the recording material. Further, when the image former 104 is constituted by an inkjet printer, the image former 104 forms the image 113 on a recording material by causing ink, which is the color material, to adhere to the recording material.

The image outputter 105 outputs the recording material on which the image 113 is formed. That is, the image outputter 105 outputs the recording material on which the image 113 has been printed.

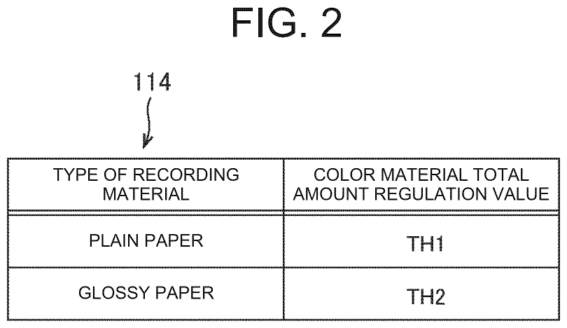

The storage 106 is a recording medium capable of recording various kinds of data, programs, and the like. Specifically, the storage 106 stores color material total amount management information 114 (see FIG. 2).

The controller 107 executes various kinds of processing in accordance with the programs and data stored in the storage 106. For example, the controller 107 is composed of a processor such as a central processing unit (CPU). The controller 107 is provided with a color information acquirer 121, a determiner 122, and a total amount regulator 123. As the processor of the controller 107 executes the processing in accordance with the program and data stored in the storage 106, the controller 107 implements the color information acquirer 121, the determiner 122, and the total amount regulator 123.

The color information acquirer 121 acquires color information 115 indicating a value of color with respect to each pixel of a region of interest R including a pixel of interest P1, which is among a plurality of pixels constituting the image 113, and at least one reference pixel P2 different from the pixel of interest P1, which is among the plurality of pixels constituting the image 113. For example, the value of color indicated by the color information 115 represents the density of the color.

The determiner 122 determines, on the basis of the color information 115, whether or not to apply color material total amount regulation for the color material made to adhere with respect to the pixel of interest P1. In other words, the determiner 122 determines, on the basis of the color information 115, whether or not to regulate the amount of color material made to adhere with respect to the pixel of interest P1. Specifically, the determiner 122 determines that the color material total amount regulation is to be applied to the pixel of interest P1 when a first representative value V1 of the values of color indicated by the color information 115 acquired with respect to the pixel of interest P1 and the at least one reference pixel P2 is greater than a color material total amount regulation value TH set according to the recording material. Meanwhile, when the first representative value V1 is less than or equal to the color material total amount regulation value TH, the determiner 122 determines that the color material total amount regulation is not to be applied to the pixel of interest P1. For example, the first representative value V1 is the average value of the values of color indicated by the color information 115 acquired with respect to the pixel of interest P1 and the at least one reference pixel P2.

When it is determined that the color material total amount regulation is to be applied to the pixel of interest P1, the total amount regulator 123 sets the color material total amount regulation on the basis of the color material total amount regulation value TH, and applies the color material total amount regulation to the pixel of interest P1. Specifically, when it is determined that the color material total amount regulation is to be applied to the pixel of interest P1, the total amount regulator 123 regulates the amount of color material to be used for the pixel of interest P1 to be less than or equal to the color material total amount regulation value TH.

FIG. 2 is a table showing an example of the color material total amount management information 114.

When the image former 104 forms the image 113 by causing a color material to adhere to a recording material, adhesivity of the color material varies according to the type of the recording material. Therefore, an appropriate color material total amount varies according to the type of the recording material. Thus, the type of the recording material and the color material total amount regulation value TH are associated with each other and registered in the color material total amount management information 114.

For example, the color material total amount regulation value TH indicates the upper limit of an amount of color material within a unit region that is set to enable preventing an occurrence of a fixation failure and winding, which are caused by a recording material to which a color material has adhered adhering to a roller conveying the recording material. For example, in a case where a recording material is colored by causing a plurality of color materials to adhere to the recording material in an overlapping manner, the color material total amount regulation value TH indicates a total value of the densities of the plurality of color materials.

For example, the type of the recording material, which is plain paper, and the color material total amount regulation value TH, which is TH1, are associated with each other and registered in the color material total amount management information 114. Further, for example, the type of the recording material, which is glossy paper, and the color material total amount regulation value TH, which is TH2, are associated with each other and registered in the color material total amount management information 114.

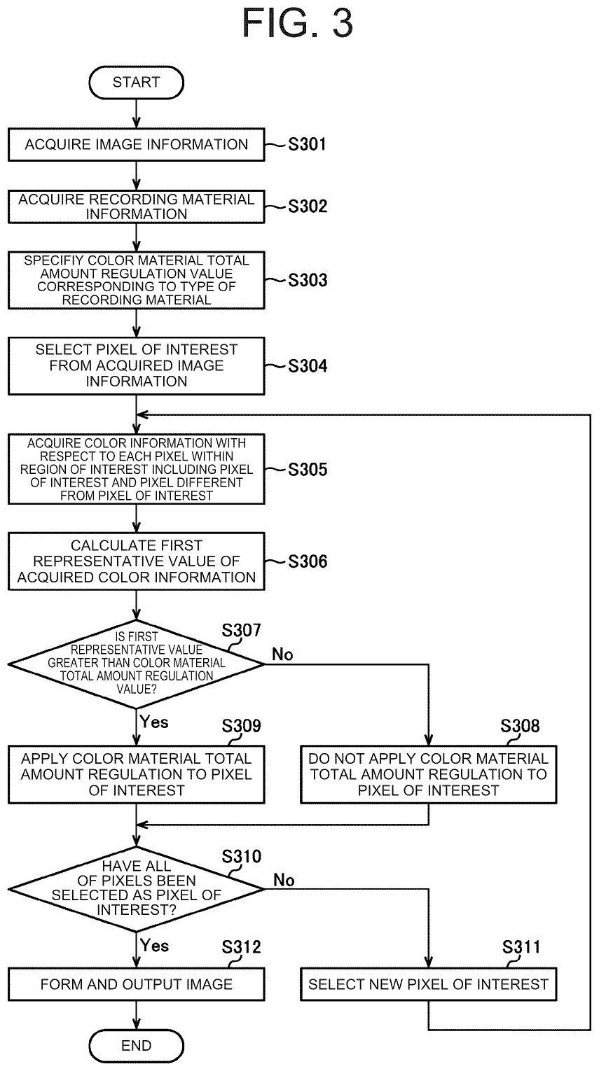

FIG. 3 is a flowchart showing an example of the operation of the image forming apparatus 100 according to the present embodiment.

In step S301, the image inputter 103 receives input of the image information 111, thereby acquiring the image information 111.

In step S302, the image inputter 103 receives input of the recording material information 112, thereby acquiring the recording material information 112.

In step S303, the color information acquirer 121 specifies the color material total amount regulation value TH corresponding to the type of the recording material. Specifically, the color information acquirer 121 specifies the color material total amount regulation value TH associated with the type of the recording material, which is indicated by the recording material information 112, in the color material total amount management information 114.

In step S304, the color information acquirer 121 selects the pixel of interest P1 from among a plurality of pixels indicated by the image information 111 acquired in step S301.

In step S305, the color information acquirer 121 acquires the color information 115 with respect to each pixel within the region of interest R including the pixel of interest P1 and at least one reference pixel P2. The color information 115 indicates the value of color of each pixel within the region of interest R. For example, the value of color indicated by the color information 115 represents the density of the color. The density of color may be represented by the density of a color material adhered to the recording material.

In step S306, the determiner 122 calculates the first representative value V1 of the color information 115. For example, the first representative value V1 is the average value of the values of color indicated by the color information 115. In that case, the first representative value V1 is the average value of the densities of the color materials adhered to the recording material within the region of interest R.

In step S307, the determiner 122 determines whether or not the first representative value V1 is greater than the color material total amount regulation value TH specified in step S303. In step S307, if the first representative value V1 is less than or equal to the color material total amount regulation value TH, in step S308, the total amount regulator 123 does not apply the color material total amount regulation to the pixel of interest P1. In that case, the total amount regulator 123 decides on a color material amount C1 at a position of the pixel of interest P1 from the value of color indicated by the color information 115 regarding the pixel of interest P1. Then, the controller 107 shifts the processing to step S310.

Meanwhile, in step S307, if the first representative value V1 is greater than the color material total amount regulation value TH, in step S309, the total amount regulator 123 applies the color material total amount regulation to the pixel of interest P1, whereby a color material amount C2 is decided to be less than or equal to the color material total amount regulation value TH with respect to the pixel of interest P1. Specifically, the total amount regulator 123 decides on the color material amount C2 to be less than or equal to the color material total amount regulation value TH by subtracting a predetermined color material amount from the color material amount C1 that is decided from the value of color indicated by the color information 115 regarding the pixel of interest P1.

For example, when the output color channels are composed of cyan (C), magenta (M), yellow (Y), and key plate=black (K), color materials of four colors that are C, M, Y, and K are used to form the image 113 on the recording material. In that case, for example, as the color materials whose densities are C=M=Y=K=100% adhere to the recording material in an overlapping manner, the recording material is colored black. That is, as the color materials whose densities of the four colors that are C, M, Y, and K total up to 400% adhere to the recording material in an overlapping manner, the recording material is colored black. However, when color materials whose densities of C, M, Y, and K total up to 400% adhere to a region having a relatively large area on the recording material, the color materials in an excessive amount are to adhere within the region. By such adhesion, a fixation failure and winding may occur due to the recording material to which the color materials have adhered adhering to a roller conveying the recording material.

Hence, in order to enable prevention of the fixation failure and winding caused by the recording material adhering to the roller, it is assumed that the color material total amount regulation value TH, which is 250%, is registered in the color material total amount management information 114 in association with the type of the recording material. In that case, by applying the color material total amount regulation to the pixel of interest P1, the total amount regulator 123 decides on the color material amount C2 having the density of C=M=Y=K=62.5%, instead of a color material amount having the density of C=M=Y=K=100%. Then, the image former 104 causes the color materials of the color material amount C2 having the density of C=M=Y=K-62.5% to adhere at the position of the pixel of interest P1 on the recording material. As a result, the image forming apparatus 100 can color the recording material black while preventing the color materials from excessively adhering at the position of the pixel of interest P1 on the recording material.

In step S310, the color information acquirer 121 determines whether or not all of the pixels indicated by the image information 111 have been selected as the pixel of interest P1. In step S310, if not all of the pixels indicated by the image information 111 have been selected as the pixel of interest P1, in step S311, the color information acquirer 121 selects a new pixel of interest P1 from among a plurality of pixels indicated by the image information 111. Then, the controller 107 returns the processing to step S305.

Meanwhile, in step S310, if all of the pixels indicated by the image information 111 are selected as the pixel of interest P1, in step S312, the image former 104 forms the image 113 based on the image information 111 on the recording material. Specifically, the image former 104 forms the image 113 at the positions of the respective pixels indicated by the image information 111 such that the color material with the color material amount C1 decided in step S308 or the color material with the color material amount C2 decided in step S309 adheres to the recording material. That is, the image former 104 forms the image 113 on the recording material by causing the color material to adhere to the recording material on the basis of a result of determination by the determiner 122. Then, the image outputter 105 outputs the recording material on which the image 113 is formed.

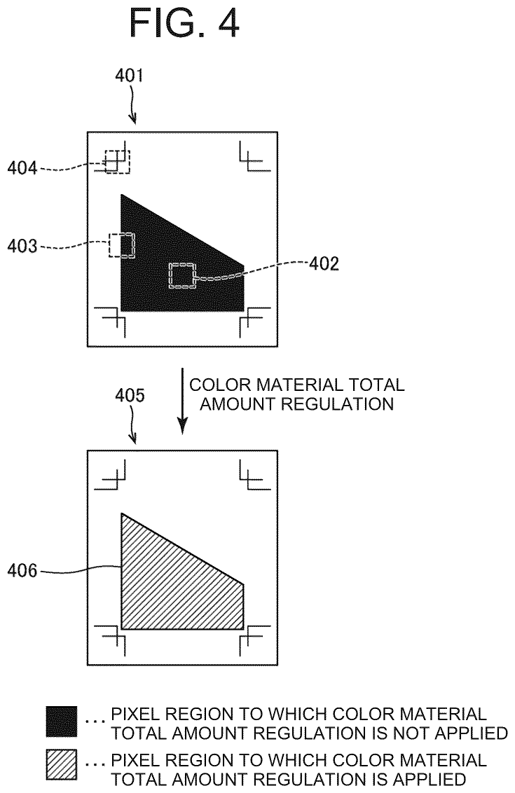

FIG. 4 is a diagram illustrating an example of a pixel region to which the color material total amount regulation is applied. An image 401 indicates an image composed of a plurality of pixels indicated by the image information 111.

For example, it is necessary to cause a color material to adhere at the position of each pixel within a region of interest 402 included in the image 401. Meanwhile, in a region of interest 403 included in the image 401, pixels for which adhesion of the color material is performed and pixels for which adhesion of the color material is not performed are mixed. Consequently, the first representative value V1 calculated for the region of interest 402 is greater than the first representative value V1 calculated for the region of interest 403.

For example, it is assumed that the first representative value V1 calculated for the region of interest 402 is greater than the color material total amount regulation value TH. In that case, the total amount regulator 123 applies the color material total amount regulation to the pixel of interest P1 included in the region of interest 402.

Meanwhile, it is assumed that the first representative value V1 calculated for the region of interest 403 is less than or equal to the color material total amount regulation value TH. In that case, the total amount regulator 123 does not apply the color material total amount regulation to the pixel of interest P1 included in the region of interest 403.

Further, a region of interest 404 includes a register mark, which is a registration mark. In this situation, since a region to which the color material adheres related to the register mark is relatively narrow, pixels for which adhesion of the color material is performed and pixels for which adhesion of the color material is not performed are mixed in the region of interest 404. Here, it is assumed that the first representative value V1 calculated for the region of interest 404 is less than or equal to the color material total amount regulation value TH. In that case, the total amount regulator 123 does not apply the color material total amount regulation to the pixel of interest P1 included in the region of interest 404.

For example, the image forming apparatus 100 does not apply the color material total amount regulation when adhesion of the color material is to be performed for a region having a relatively small area, such as a register mark or a star mark, which is the registration mark. As a result, the image forming apparatus 100 can prevent the region from becoming unclear on the recording material on which the image 113 is formed.

An image 405 is an image formed on the recording material as a result of a determination made by the total amount regulator 123 as to whether or not to apply the color material total amount regulation to each of the pixels indicated by the image 401. For example, for pixels at the positions inside a region 406 included in the image 405, the color material total amount regulation is applied. Meanwhile, the color material total amount regulation is not applied to pixels at the positions at a boundary of the region 406. As a result, the image forming apparatus 100 can prevent the boundary of the region 406 from becoming unclear.

Similarly, the color material total amount regulation is not applied to the register mark, which is the registration mark indicated at each of the four corners of the image 405. As a result, the image forming apparatus 100 can prevent the register marks indicated at the four corners of the image 405 from becoming unclear.

As described above, the image forming apparatus 100 can cause an appropriate amount of color material to adhere to a recording material and also prevent the recording material from becoming unclear.

### Second Embodiment

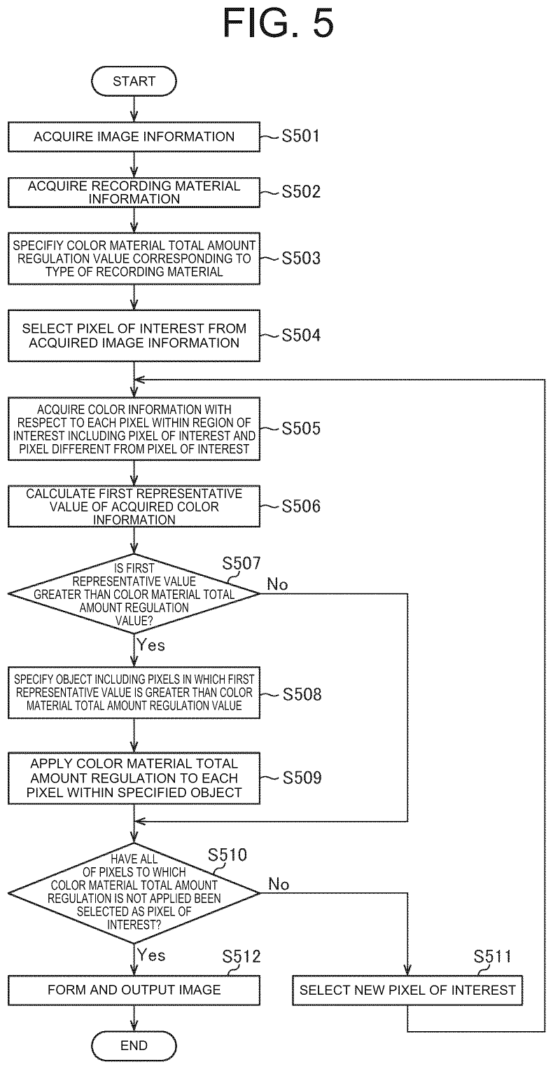

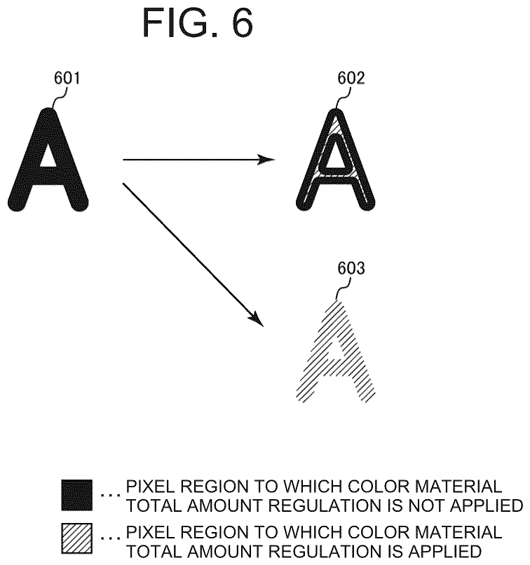

A second embodiment will be described with reference to FIGS. 5 to 6. In the drawings, the same or similar elements are denoted by the same reference numerals, and redundant description thereof will be omitted. Configurations and processing having functions substantially in common with the other embodiments will be referred to by the common reference numerals to omit descriptions thereof, and points different from the other embodiments will be described.

The configuration of an image forming apparatus 100 according to the present embodiment is as exemplified in FIG. 1.

A determiner 122 according to the present embodiment determines, when a first representative value V1 is greater than a color material total amount regulation value TH, that color material total amount regulation is to be applied to each pixel of an object including a pixel of interest P1. Meanwhile, when the first representative value V1 is less than or equal to the color material total amount regulation value, the determiner 122 according to the present embodiment determines that the color material total amount regulation is not to be applied to each pixel of the object including the pixel of interest P1.

When it is determined that the color material total amount regulation is to be applied to each pixel of the object including the pixel of interest P1, a total amount regulator 123 according to the present embodiment sets the color material total amount regulation on the basis of the color material total amount regulation value TH, and applies the color material total amount regulation to each pixel of the object.

FIG. 5 is a flowchart showing an example of the operation of the image forming apparatus 100 according to the present embodiment. Since the processing from step S501 to step S506 is the same as the processing from step S301 to step S306 exemplified in FIG. 3, detailed description thereof will be omitted.

In step S507, the determiner 122 determines whether or not the first representative value V1 is greater than the color material total amount regulation value TH. In step S507, if the first representative value V1 is less than or equal to the color material total amount regulation value TH, a controller 107 shifts the processing to step S510.

Meanwhile, in step S507, if the first representative value V1 is greater than the color material total amount regulation value TH, the determiner 122 specifies, in step S508, an object including the pixel of interest P1 and also including pixels in which the first representative value V1 is greater than the color material total amount regulation value TH.

In step S509, the total amount regulator 123 applies the color material total amount regulation to each of the pixels within the specified object.

In step S510, a color information acquirer 121 determines whether or not all of the pixels to which the color material total amount regulation is not applied among all of the pixels indicated by image information 111 have been selected as the pixel of interest P1. In step S510, among all of the pixels indicated by the image information 111, if not all of the pixels to which the color material total amount regulation is not applied have been selected as the pixel of interest P1, in step S511, the color information acquirer 121 selects a new pixel of interest P1 from among a plurality of pixels indicated by the image information 111. Note that when the object is specified in step S508, the new pixel of interest P1 to be selected is a pixel different from the pixels within the specified object. Then, the controller 107 returns the processing to step S505.

Meanwhile, in step S510, among all of the pixels indicated by the image information 111, if all of the pixels to which the color material total amount regulation is not applied have been selected as the pixel of interest P1, in step S512, an image former 104 forms an image 113 based on the image information 111 on a recording material, and an image outputter 105 outputs the recording material on which the image 113 is formed. Since the processing of step S512 is the same as the processing of step S312 exemplified in FIG. 3, detailed description thereof will be omitted.

FIG. 6 is a diagram illustrating an example of an object 601 included in an image output when the color material total amount regulation is not applied, an example of an object 602 included in the image 113 output by the image forming apparatus 100 according to the first embodiment, and an example of an object 603 included in the image 113 output by the image forming apparatus 100 according to the present embodiment.

For example, when the total amount regulator 123 according to the first embodiment applies the color material total amount regulation to the object 601, as exemplified by the object 602, a portion with adhesion of a color material by having total amount regulation applied and a portion with adhesion of the color material without having the color material total amount regulation applied are mixed. As a result, as exemplified by the object 602, even when the values of color indicated by color information 115 are uniform, saturation and brightness become non-uniform within the object included in the image 113.

Meanwhile, when the total amount regulator 123 according to the present embodiment applies the color material total amount regulation to the object 601, as exemplified by the object 603, the color material total amount regulation is applied to the entire object 603. Consequently, the image forming apparatus 100 according to the present embodiment can color a recording material such that the saturation and the brightness become uniform when the values of color indicated by the color information 115 are uniform within the object included in the image 113.

As described above, the image forming apparatus 100 according to the present embodiment determines whether or not to apply the color material total amount regulation for each object composed of a plurality of pixels indicated by the image information 111. Thus, the image forming apparatus 100 according to the present embodiment can cause an appropriate amount of color material to adhere to a recording material and also prevent the recording material from becoming unclear, and avoid occurrence of unevenness in the amount of the color material made to adhere to an object filled with the same color.

### Third Embodiment

A third embodiment will be described. In the drawings, the same or similar elements are denoted by the same reference numerals, and redundant description thereof will be omitted. Configurations and processing having functions substantially in common with the other embodiments will be referred to by the common reference numerals to omit descriptions thereof, and points different from the other embodiments will be described.

The configuration of an image forming apparatus 100 according to the present embodiment is as exemplified in FIG. 1.

For example, when the pixel value of each pixel indicates an R value, a G value, and a B value in an RGB (Red, Green, Blue) color space, each of the R value, the G value, and the B value indicated by image information 111 is not a value representing the amount of color material. Alternatively, when the image information 111 indicates the color name of a spot color defined by a color sample, the color name indicated by the image information 111 does not represent the amount of color material.

Therefore, for example, when the output color channels are C, M, Y, and K color channels, a storage 106 according to the present embodiment stores information for converting the values indicated by the RGB color space into values indicated by a CMYK color space. For example, the information for converting the values indicated by the RGB color space into values indicated by a CMYK color space represents a conversion table whereby the R value, the G value, and the B value are converted into a C value, an M value, a Y value, and a K value. Alternatively, the storage 106 according to the present embodiment may store information for converting the color name of the spot color defined by the color sample into a C value, an M value, a Y value, and a K value.

The image information 111 may indicate image data to which halftone processing is applied. When the halftone processing is applied to the image data, a value indicated by the CMYK color space with respect to each pixel indicated by the image data is represented by a binary value.

For the image data indicated by the image information 111, the amounts of the color material for the same pixel differ from each other in a case where the halftone processing is applied and in a case where the halftone processing is not applied. Further, in the image data to which the halftone processing is applied, a plurality of color materials whose densities are relatively high may overlap one another locally, whereby a total value of the densities of the color materials may locally exceed a color material total amount regulation value TH. As a result, in the image data to which the halftone processing is applied, image deterioration may occur if total amount regulation is applied to a region in which the total of the densities of the color materials exceeds the color material total amount regulation value TH.

For this reason, the color material total amount regulation value TH for the image data to which the halftone processing is applied may be set to be higher than the color material total amount regulation value TH for the image data to which the halftone processing is not applied. As a result, when the image information 111 indicates image data to which halftone processing is applied, the image forming apparatus 100 can suppress excessive application of the color material total amount regulation.

### Fourth Embodiment

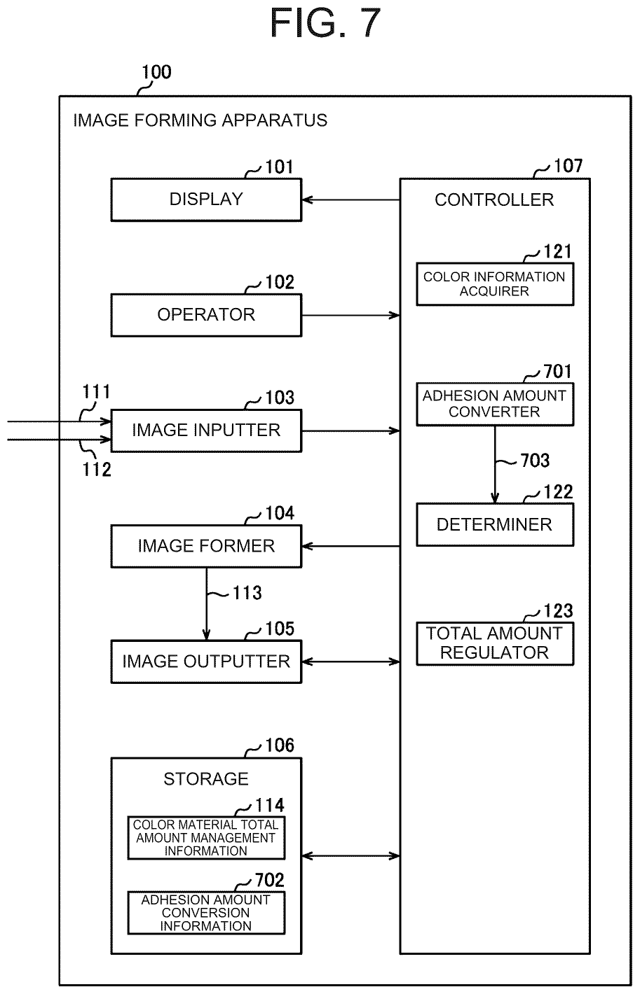

A fourth embodiment will be described with reference to FIGS. 7 to 9. In the drawings, the same or similar elements are denoted by the same reference numerals, and redundant description thereof will be omitted. Configurations and processing having functions substantially in common with the other embodiments will be referred to by the common reference numerals to omit descriptions thereof, and points different from the other embodiments will be described.

FIG. 7 is a block diagram illustrating an example of a configuration of an image forming apparatus 100 according to the present embodiment. A difference between the image forming apparatus 100 illustrated in FIG. 7 and the image forming apparatus 100 illustrated in FIG. 1 is that the image forming apparatus 100 illustrated in FIG. 7 is provided with an adhesion amount converter 701, and adhesion amount conversion information 702 is stored in a storage 106.

The adhesion amount conversion information 702 indicates a relationship between a color information value indicating the value of color of an output color channel and an amount of adhesion of a color material.

In the image forming apparatus 100 according to the present embodiment, color information 115 acquired with respect to a pixel of interest P1 and at least one reference pixel P2 indicates the value of color converted into the output color channel with respect to the pixel of interest P1 and the at least one reference pixel P2.

The adhesion amount converter 701 converts the color information 115, which has been acquired with respect to the pixel of interest P1 and the at least one reference pixel P2, into an adhesion amount 703 of the color material made to adhere to a recording material with respect to the pixel of interest P1 and the at least one reference pixel P2.

A determiner 122 according to the present embodiment determines whether or not to apply color material total amount regulation to the pixel of interest P1, on the basis of the adhesion amount 703 obtained by the conversion with respect to the pixel of interest P1 and the at least one reference pixel P2. Specifically, the determiner 122 determines, when a second representative value V2 of the adhesion amounts 703 obtained by the conversion with respect to the pixel of interest P1 and the at least one reference pixel P2 is greater than a color material total amount regulation value TH, that the color material total amount regulation is to be applied to the pixel of interest P1. Meanwhile, when the second representative value V2 is less than or equal to the color material total amount regulation value TH, the determiner 122 determines that the color material total amount regulation is not to be applied to the pixel of interest P1. For example, the second representative value V2 is the average value of the adhesion amounts 703 with respect to the pixel of interest P1 and the at least one reference pixel P2.

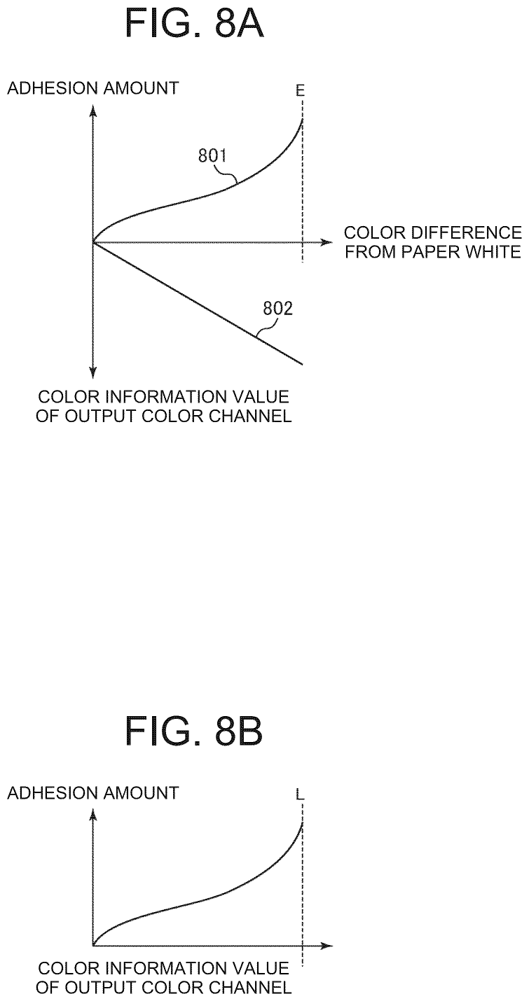

FIG. 8A is a graph showing an example of a relationship among a color difference from paper white, an adhesion amount, and a color information value of an output color channel. In a graph 802 illustrated in FIG. 8A, the horizontal axis represents the color difference from paper white, and the vertical axis represents the color information value of the output color channel. In a graph 801 illustrated in FIG. 8A, the horizontal axis represents the color difference from paper white, and the vertical axis represents the adhesion amount. It is assumed that the color information value of the output color channel exemplified in FIG. 8A indicates a value among a C value, an M value, a Y value, and a K value. Therefore, it is assumed that the color difference from paper white exemplified in FIG. 8A indicates a color of an object surface determined from the brightness and saturation to be perceived with respect to the color of the value indicated by the color information value of the output color channel. Similarly, it is assumed that the adhesion amount exemplified in FIG. 8A indicates the amount of adhesion of the color material with respect to the color of the value indicated by the color information value of the output color channel.

As illustrated by the graph 802, the color difference from paper white and the color information value of the output color channel have a linear relationship, and as the color difference from paper white increases, the color information value of the output color channel increases linearly. Meanwhile, as illustrated by the graph 801, the color difference from paper white and the adhesion amount have a nonlinear relationship. Here, the brightness and saturation to be perceived do not exceed a maximum value of the brightness and a maximum value of the saturation of the color material. Therefore, as illustrated in FIG. 8A, when the adhesion amount increases, the brightness and saturation to be perceived converge to a color difference E determined from the maximum value of the brightness and the maximum value of the saturation of the color material.

FIG. 8B is a graph showing an example of a relationship between a color information value indicating the value of color of an output color channel and an adhesion amount. In FIG. 8B, the horizontal axis represents the color information value indicating the value of color of an output color channel, and the vertical axis represents the adhesion amount. As illustrated in FIG. 8B, brightness and saturation calculated from a maximum value of the color information value of the output color channel do not exceed a maximum value of the brightness and a maximum value of the saturation of the color material. Therefore, as illustrated in FIG. 8B, when the adhesion amount increases, the color information value of the output color channel converges to a predetermined maximum value L.

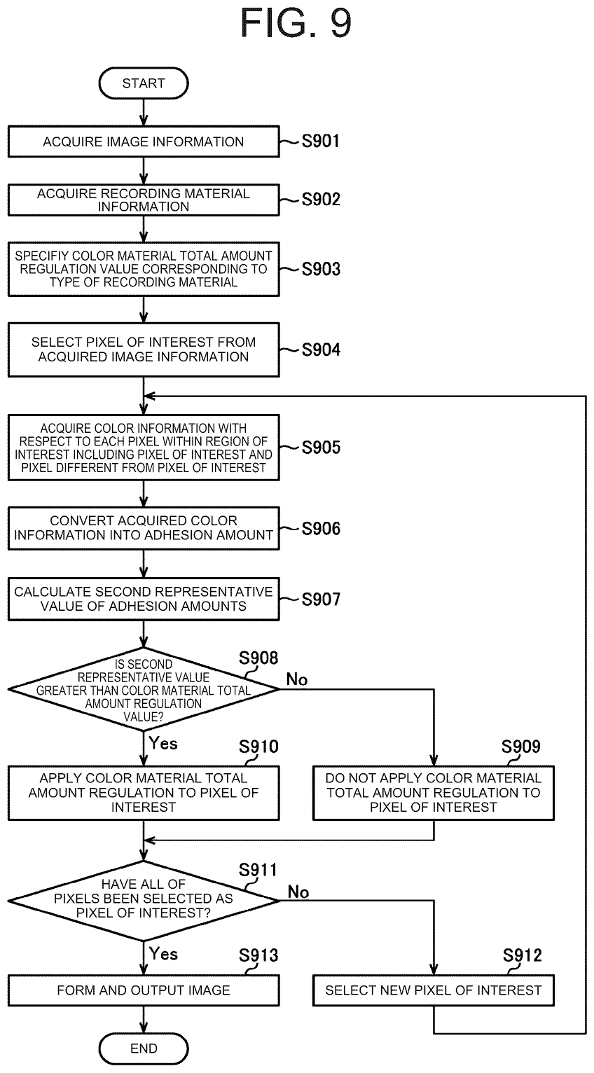

FIG. 9 is a flowchart showing an example of the operation of the image forming apparatus 100 according to the present embodiment. Since the processing from step S901 to step S905 is the same as the processing from step S301 to step S305 exemplified in FIG. 3, detailed description thereof will be omitted.

In step S906, the adhesion amount converter 701 converts the color information 115 with respect to each pixel within a region of interest R into the adhesion amount 703. Specifically, for each pixel within the region of interest R, the adhesion amount converter 701 converts the value of color indicated by the color information 115 into a value of color of the output color channel. Then, the adhesion amount converter 701 decides on the adhesion amount 703 for each pixel within the region of interest R from the relationship between the value of color of the output color channel and the adhesion amount, which is indicated by the adhesion amount conversion information 702.

In step S907, the determiner 122 calculates the second representative value V2 of the adhesion amounts 703 with respect the region of interest R. For example, the second representative value V2 is the average value of the adhesion amounts 703 with respect to the respective pixels within the region of interest R.

In step S908, the determiner 122 determines whether or not the second representative value V2 is greater than the color material total amount regulation value TH. In step S908, if the second representative value V2 is less than or equal to the color material total amount regulation value TH, in step S909, a total amount regulator 123 does not apply the color material total amount regulation to the pixel of interest P1. Then, a controller 107 shifts the processing to step S911.

Meanwhile, in step S908, if the second representative value V2 is greater than the color material total amount regulation value TH, in step S910, the total amount regulator 123 applies the color material total amount regulation to the pixel of interest P1. Since the processing of step S910 is the same as the processing of step S309 exemplified in FIG. 3, detailed description thereof will be omitted. Then, the controller 107 shifts the processing to step S911. Since the processing of step S911 and thereafter is the same as the processing of step S310 and thereafter exemplified in FIG. 3, detailed description thereof will be omitted.

As described above, the image forming apparatus 100 according to the present embodiment determines whether or not to apply the color material total amount regulation to the pixel of interest P1, on the basis of the amount of color material substantially necessary for each pixel within the region of interest R. As a result, the image forming apparatus 100 according to the present embodiment can more effectively apply the color material total amount regulation.

### Fifth Embodiment

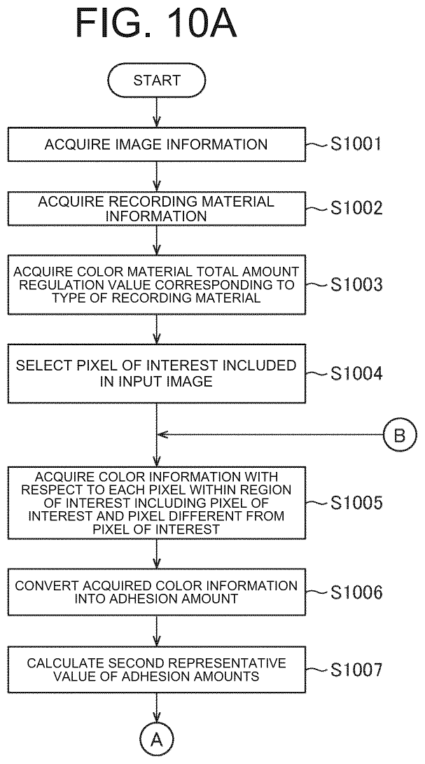

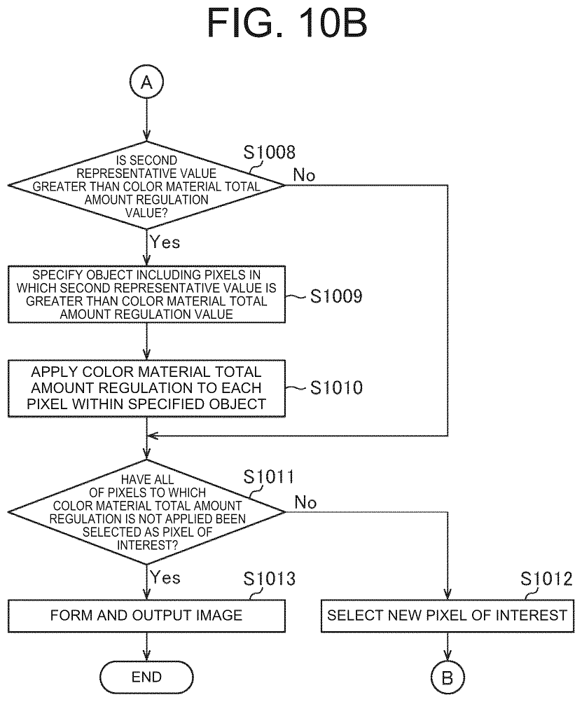

A fifth embodiment will be described with reference to FIGS. 10A to 10B. In the drawings, the same or similar elements are denoted by the same reference numerals, and redundant description thereof will be omitted. Configurations and processing having functions substantially in common with the other embodiments will be referred to by the common reference numerals to omit descriptions thereof, and points different from the other embodiments will be described.

The configuration of an image forming apparatus 100 according to the present embodiment is as exemplified in FIG. 7.

A determiner 122 according to the present embodiment determines, when a second representative value V2 is greater than a color material total amount regulation value TH, that color material total amount regulation is to be applied to each pixel of an object including a pixel of interest P1. Meanwhile, when the second representative value V2 is less than or equal to the color material total amount regulation value TH, the determiner 122 determines that the color material total amount regulation is not to be applied to each pixel of the object including the pixel of interest P1.

When it is determined that the color material total amount regulation is to be applied to each pixel of the object including the pixel of interest P1, a total amount regulator 123 according to the present embodiment sets the color material total amount regulation on the basis of the color material total amount regulation value, and applies the color material total amount regulation to each pixel of the object.

FIGS. 10A to 10B are flowcharts showing an example of the operation of the image forming apparatus 100 according to the present embodiment. Since the processing from step S1001 to step S1005 exemplified in FIG. 10A is similar to the processing from step S301 to step S305 exemplified in FIG. 3, detailed description thereof will be omitted. In addition, since the processing of step S1006 and step S1007 exemplified in FIG. 10A, and the processing of step S1008 exemplified in FIG. 10B are the same as the processing from step S906 to step S908 exemplified in FIG. 9, detailed description thereof will be omitted.

In step S1008, the determiner 122 determines whether or not the second representative value V2 of adhesion amounts 703 is greater than the color material total amount regulation value TH. In step S1008, if the second representative value V2 is less than or equal to the color material total amount regulation value TH, a controller 107 shifts the processing to step S1011.

Meanwhile, in step S1008, if the second representative value V2 is greater than the color material total amount regulation value TH, the determiner 122 specifies, in step S1009, an object including the pixel of interest P1 and also including pixels in which the second representative value V2 is greater than the color material total amount regulation value TH.

In step S1010, the total amount regulator 123 applies the color material total amount regulation to each of the pixels within the specified object.

In step S1011, a color information acquirer 121 determines whether or not all of the pixels to which the color material total amount regulation is not applied among all of the pixels indicated by image information 111 have been selected as the pixel of interest. In step S1011, among all of the pixels indicated by the image information 111, if not all of the pixels to which the color material total amount regulation is not applied have been selected as the pixel of interest, in step S1012, the color information acquirer 121 selects a new pixel of interest P1 from among a plurality of pixels indicated by the image information 111. Note that when the object is specified in step S1009, the new pixel of interest P1 to be selected is a pixel different from the pixels within the specified object. Then, the controller 107 returns the processing to step S1005 exemplified in FIG. 10A.

Meanwhile, in step S1011, among all of the pixels indicated by the image information 111, if all of the pixels to which the color material total amount regulation is not applied have been selected as the pixel of interest, in step S1013, an image former 104 forms an image 113 based on the image information 111 on a recording material, and an image outputter 105 outputs the recording material on which the image 113 is formed. Since the processing of step S1013 is the same as the processing of step S312 exemplified in FIG. 3, detailed description thereof will be omitted.

As described above, the image forming apparatus 100 according to the present embodiment can achieve the same effects and advantages as those of the image forming apparatus 100 according to the second embodiment, and can also achieve the same effects and advantages as those of the image forming apparatus 100 according to the fourth embodiment.

### Sixth Embodiment

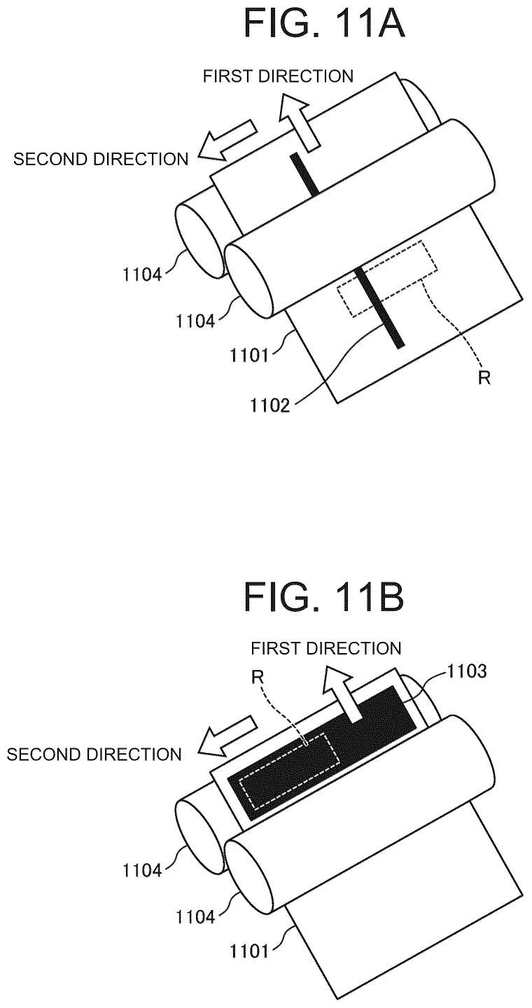

A sixth embodiment will be described with reference to FIGS. 11A to 11B. In the drawings, the same or similar elements are denoted by the same reference numerals, and redundant description thereof will be omitted. Configurations and processing having functions substantially in common with the other embodiments will be referred to by the common reference numerals to omit descriptions thereof, and points different from the other embodiments will be described.

FIG. 11A is an illustration showing an example of a region 1102 where a color material adheres to a recording material 1101. FIG. 11B is an illustration showing an example of a region 1103 where a color material adheres to the recording material 1101.

An image forming apparatus 100 is provided with a roller 1104 as a conveying portion arranged such that a region in contact with the recording material 1101 is orthogonal to a first direction, which is a direction in which the recording material 1101 is conveyed. The region 1102 has a length that is shorter in a second direction, which is orthogonal to the first direction, than in the first direction in which the recording material 1101 is conveyed. When a color material adheres to the region 1102 on the recording material 1101, the color material adheres to a part of the roller 1104 along the second direction. As exemplified by the region 1102, even when a region in which the amount of adhesion of the color material is relatively large has a length extending in the first direction, if the length along the second direction is relatively short, a fixation failure and winding which are caused by the recording material 1101 adhering to the roller 1104 are less likely to occur.

Meanwhile, the region 1103 has a length extending over the entire roller 1104 along the second direction. When a color material adheres to the region 1103 on the recording material 1101, the color material adheres over the entire the roller 1104 along the second direction. As exemplified by the region 1103, even when a region in which the amount of adhesion of the color material is relatively large has a length extending in the first direction, if the length along the second direction is relatively long, a fixation failure and winding which are caused by the recording material 1101 adhering to the roller 1104 are more likely to occur. Therefore, there is a possibility that a fixation failure and winding due to a large amount of the color material adhering to the roller 1104 may occur in a case where the color material adheres to the region 1103 on the recording material 1101, as compared to a case where the color material adheres to the region 1102 on the recording material 1101.

Here, a region of interest R according to the present embodiment is rectangular, and has a length that is longer along the second direction than along the first direction in the recording material 1101 on which an image 113 is formed. A determiner 122 can thereby determine whether or not an excessive amount of color material may adhere to the roller 1104. Further, when an excessive amount of color material may adhere to the recording material 1101, a total amount regulator 123 applies color material total amount regulation. By doing so, the image forming apparatus 100 can prevent an occurrence of a fixation failure and winding which are caused by the recording material 1101 adhering to the roller 1104.

Note that when an excessive amount of color material has adhered to an end portion of the recording material 1101 on the first direction side, a fixation failure and winding are more likely to occur due to the end portion of the recording material 1101 adhering to the roller 1104 with the end portion of the recording material 1101 being a starting point. Therefore, the region of interest R at a position on the first direction side in the recording material 1101 may have an area larger than that of the region of interest R at a position on the opposite side of the first direction in the recording material 1101. Thus, the determiner 122 can more appropriately determine whether or not the amount of adhesion of the color material is relatively large at the end portion of the recording material 1101 on the first direction side. As a result, when an excessive amount of color material may adhere to the end portion of the recording material 1101 on the first direction side, the total amount regulator 123 can more reliably prevent an occurrence of a fixation failure and winding which are caused by the end portion of the recording material 1101 adhering to the roller 1104.

### Seventh Embodiment

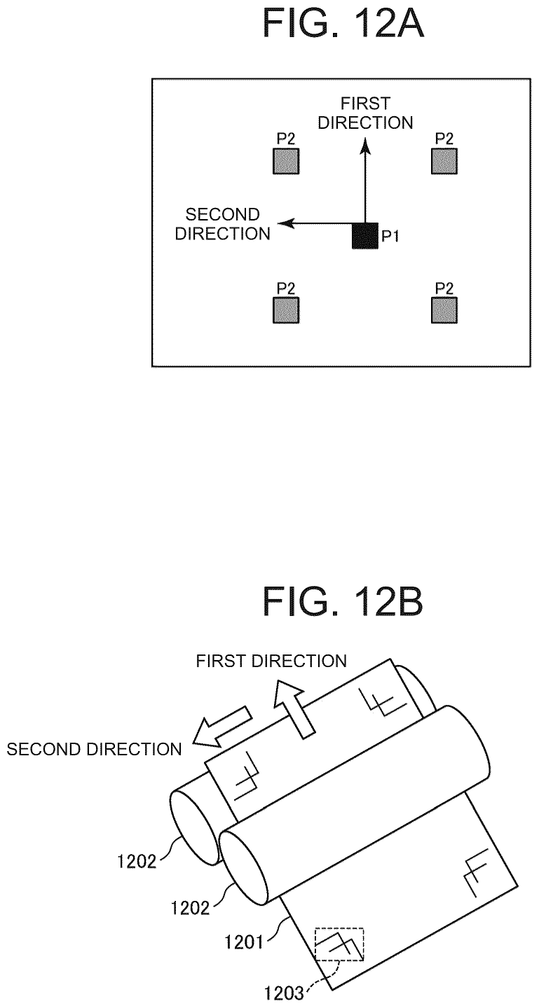

A seventh embodiment will be described with reference to FIGS. 12A to 12B. In the drawings, the same or similar elements are denoted by the same reference numerals, and redundant description thereof will be omitted. Configurations and processing having functions substantially in common with the other embodiments will be referred to by the common reference numerals to omit descriptions thereof, and points different from the other embodiments will be described.

FIG. 12A is a diagram illustrating an example of a relationship between a pixel of interest P1 and a reference pixel P2 in an image forming apparatus 100 according to the present embodiment. As illustrated in FIG. 12A, in the image forming apparatus 100 according to the present embodiment, the position of at least one reference pixel P2, on a recording material on which an image 113 is formed, is a position that is not aligned along either a second direction or a first direction with respect to the position of the pixel of interest P1.

FIG. 12B is a diagram illustrating an example of a recording material 1201 on which a register mark, which is a registration mark for printed product management, is printed. The image forming apparatus 100 is provided with a roller 1202 as a conveying portion arranged such that a region in contact with the recording material 1201 is orthogonal to the first direction, which is a direction in which the recording material 1201 is conveyed. A register mark for printed product management is printed in a region 1203 included in the recording material 1201. When a color material is adhering to a thin line portion such as a register mark included in the region 1203, the color material as such is less likely to cause a fixation failure and winding due to the adhesion of the recording material 1201 to the roller 1202. However, if a total amount regulator 123 determines that color material total amount regulation concerning the amount of color material is to be applied to a thin line such as a register mark included in the region 1203, the color material may not adhere to the thin line sufficiently, and the thin line may become unclear.

However, in the image forming apparatus 100 according to the present embodiment, the position of the at least one reference pixel P2 is a position that is not aligned along either the second direction or the first direction with respect to the position of the pixel of interest P1. Consequently, it is possible to prevent the color material total amount regulation concerning the amount of color material from being applied to the thin line such as the register mark. Further, when a rectangular region is to be referred to, it is necessary to refer to a relatively large number of pixels. Meanwhile, it is sufficient if the image forming apparatus 100 according to the present embodiment refers to limited pixels at predetermined positions. Therefore, the number of pixels to be referred to is smaller than that of the case of referring to a rectangular region. As a result, the image forming apparatus 100 according to the present embodiment is enabled to reduce the memory capacity and increase the processing speed, whereby the subject of total amount regulation can be efficiently determined.

Each of the processes executed in the above embodiments is not limited to the processing mode exemplified in each of the embodiments. The above-described functional blocks may be implemented by using either a logic circuit (hardware) formed in an integrated circuit or the like or software using a CPU. The above implementation may be executed by a plurality of computers. For example, in the processes executed by the respective functional blocks of the controller 107 of the image forming apparatus 100, a part of the processes may be executed by another computer, or all of the processes may be respectively allocated to and executed by a plurality of computers.

The present disclosure is not limited to the above-described embodiments, and may be replaced with a configuration which is substantially the same as the configuration indicated in the above-described embodiments, a configuration which exhibits the same effects and advantages, or a configuration which can achieve the same object. In the present disclosure, embodiments, which can be obtained by appropriately combining the technical measures respectively disclosed in different embodiments, are also included in the technical scope of the present disclosure. Furthermore, a new technical feature can be formed by combining the technical measures respectively disclosed in the embodiments.

What is claimed is:

1. An image forming apparatus comprising,
a controller
acquires color information indicating a value of color with respect to each pixel of a region of interest including a pixel of interest among a plurality of pixels constituting an image, and at least one reference pixel different from the pixel of interest among the plurality of pixels; and
determines, based on the color information, whether or not to apply color material total amount regulation for the color material made to adhere with respect to the pixel of interest, and
an image former forms the image on the recording material by causing the color material to adhere to the recording material based on a result of determination by the controller.

2. The image forming apparatus according to claim 1, wherein the controller:
determines that the color material total amount regulation is to be applied to the pixel of interest when a first representative value of values of color, which are indicated by the color information acquired with respect to the pixel of interest and the at least one reference pixel, is greater than a color material total amount regulation value set according to the recording material, and determines that the color material total amount regulation is not to be applied to the pixel of interest when the first representative value is less than or equal to the color material total amount regulation value; and
sets, when it is determined that the color material total amount regulation is to be applied to the pixel of interest, the color material total amount regulation based on the color material total amount regulation value, and applies the color material total amount regulation to the pixel of interest.

3. The image forming apparatus according to claim 2, wherein the controller:
determines that the color material total amount regulation is to be applied to each pixel of an object including the pixel of interest when the first representative value is greater than the color material total amount regulation value, and determines that the color material total amount regulation is not to be applied to each pixel of the object when the first representative value is less than or equal to the color material total amount regulation value; and
sets, when it is determined that the color material total amount regulation is to be applied to each pixel of the object, the color material total amount regulation based on the color material total amount regulation value, and applies the color material total amount regulation to each pixel of the object.

4. The image forming apparatus according to claim 2, wherein the first representative value is an average value of the values of color indicated by the color information acquired with respect to the pixel of interest and the at least one reference pixel.

5. The image forming apparatus according to claim 1, wherein the color information acquired with respect to the pixel of interest and the at least one reference pixel indicates a value of color converted into an output color channel with respect to the pixel of interest and the at least one reference pixel.

6. The image forming apparatus according to claim 1, wherein the controller:
converts the color information acquired with respect to the pixel of interest and the at least one reference pixel into an adhesion amount of the color material made to adhere to the recording material with respect to the pixel of interest and the at least one reference pixel; and
determines whether or not to apply the color material total amount regulation to the pixel of interest based on the adhesion amount obtained by the conversion with respect to the pixel of interest and the at least one reference pixel.

7. The image forming apparatus according to claim 6, wherein the controller:
determines that the color material total amount regulation is to be applied to the pixel of interest when a second representative value of adhesion amounts, which are obtained by the conversion with respect to the pixel of interest and the at least one reference pixel, is greater than a color material total amount regulation value set according to the recording material, and determines that the color material total amount regulation is not to be applied to the pixel of interest when the second representative value is less than or equal to the color material total amount regulation value; and
sets, when it is determined that the color material total amount regulation is to be applied to the pixel of interest, the color material total amount regulation based on the color material total amount regulation value, and applies the color material total amount regulation to the pixel of interest.

8. The image forming apparatus according to claim 7, wherein the controller:
determines that the color material total amount regulation is to be applied to each pixel of an object including the pixel of interest when the second representative value is greater than the color material total amount regulation value, and determines that the color material total amount regulation is not to be applied to each pixel of the object when the second representative value is less than or equal to the color material total amount regulation value; and
sets, when it is determined that the color material total amount regulation is to be applied to each pixel of the object, the color material total amount regulation based on the color material total amount regulation value, and applies the color material total amount regulation to each pixel of the object.

9. The image forming apparatus according to claim 7, wherein the second representative value is an average value of the adhesion amounts with respect to the pixel of interest and the at least one reference pixel.

10. The image forming apparatus according to claim 1, further comprising a conveying portion arranged such that a region in contact with the recording material is orthogonal to a first direction, which is a direction in which the recording material is conveyed, wherein
the region of interest is rectangular, and has a length that is longer along a second direction orthogonal to the first direction than along the first direction in the recording material on which the image is formed.

11. The image forming apparatus according to claim 1, further comprising a conveying portion arranged such that a region in contact with the recording material is orthogonal to a first direction, which is a direction in which the recording material is conveyed, wherein
on the recording material on which the image is formed, a position of the at least one reference pixel is a position that is not aligned along either a second direction orthogonal to the first direction or the first direction with respect to a position of the pixel of interest.

12. An image forming method comprising:
acquiring color information indicating a value of color with respect to each pixel of a region of interest including a pixel of interest among a plurality of pixels constituting an image, and at least one reference pixel different from the pixel of interest among the plurality of pixels;
determining, based on the color information, whether or not to apply color material total amount regulation for a color material made to adhere with respect to the pixel of interest; and
causing the color material to adhere to a recording material based on a determination result and forming the image on the recording material.

13. A non-transitory computer-readable recording medium storing therein a program which causes a computer to implement:
acquiring color information indicating a value of color with respect to each pixel of a region of interest including a pixel of interest among a plurality of pixels constituting an image, and at least one reference pixel different from the pixel of interest among the plurality of pixels;
determining, based on the color information, whether or not to apply color material total amount regulation for a color material made to adhere with respect to the pixel of interest; and
causing the color material to adhere to a recording material based on a determination result and forming the image on the recording material.
